(19) United States
(12) Patent Application Publication
(10) Pub. No.: US 2020/0303092 A1
(43) Pub. Date: Sep. 24, 2020

(54) ELECTRICALLY CONDUCTIVE CABLE AND METHOD

(71) Applicant: Jeffrey Smith, Springfield, VA (US)

(72) Inventor: Jeffrey Smith, Springfield, VA (US)

(21) Appl. No.: 16/826,263

(22) Filed: Mar. 22, 2020

Related U.S. Application Data
(60) Provisional application No. 62/822,926, filed on Mar. 24, 2019.

(51) Int. Cl. H01B 7/30; H01B 7/00; H01B 11/00

(52) U.S. Cl. CPC H01B 7/30; H01B 11/002; H01B 7/0009

(57) ABSTRACT

A method for reducing frequency dependent energy loss and phase errors from end to end as a function of the frequency of audio-range signals conducted therein including obtaining an electrical wire having a first end and an opposing second end and comprising of an electrically conductive metal with a conductivity between 0 and about 3.2* 10⁶ (ohm-meter)⁻¹ or between 0 and about 5.5% International Annealed Copper Standard (IACS), wherein the electrically conductive metal includes a relative magnetic permeability between 0 and 2, and transmitting audio-range signals from the first end to the second end, wherein the frequency dependent energy loss and phase from the first end to the second end is a function of a frequency of the audio-range signals transmitted therein.

### BACKGROUND OF THE INVENTION

### 1. Field of the Invention

The present invention relates generally to devices for improving the quality of electrically conductive signal transmission cables. More specifically, the present invention pertains to electrically conductive cables for routing electrical signals within audio systems. The present invention is particularly, though not exclusively, useful in reducing or eliminating distortions, phase errors, and other undesirable alterations of the electrical signal caused by the electrical characteristics of the metal conductors of conventional conductive cables. The present invention further relates to a process for reducing frequency dependent energy loss and phase errors within electromagnetic waveforms transmitted through electrically conductive cables.

### 2. Description of Related Art

Since the invention of the first devices for recording and reproducing sound, people have sought to achieve the goal of reproducing sound with such precision and accuracy that it is indistinguishable from the live event. Though that goal has not been achieved, modern day audio recording and reproduction systems are capable of producing music that is stunningly realistic.

This stunning realism is primarily due to advancements in recording methods and equipment, and in playback components, amplification, and speakers. During this advancement, less attention was given to the conductive cables that linked the audio equipment and, more often than not, cables were relegated to the category of accessory rather than a true stereo system component.

Conventional cables in audio recording and playback systems typically fall in to two categories: interconnect and speaker cables. Interconnect cables carry analog or digital music signals between low level or line level audio components like microphones, recorders, turntables, CD or tape players, and pre-amplifiers, and consist of positive and ground or neutral conductors. An interconnect cable may have a single positive conductor to carry the entire musical signal or it may have a positive conductor for each electrical phase of the musical signal. A balanced interconnect or microphone cable, for example, will have a ground conductor and two positive conductors to carry the positive and negative phases of the electrical music signal. Speaker cables connect the amplifiers to the speakers and also consist of positive and ground or neutral conductors.

When cables were considered, in attempts to determine and describe audible differences between them, only the resistance, inductance, and capacitance (RLC) characteristics were typically analyzed. Thus, it was nearly impossible to predict or explain how wires and cables could possibly affect sound quality. It was not until skin effect, conductor size, and phase and group delay were accounted for that credible improvements were made in audio cable design.

Two very different models are used to describe the flow of electromagnetic energy. First, and most prevalent, is the ‘water in a pipe’ analogy in which electrical current, in the form of electrons, is said to move through electrical conductors like water flowing in a pipe.

Related art almost exclusively uses this model to describe and define the phenomenon of skin effect. Notably, the Brisson patent (U.S. Pat. No. 4,538,023A issued in 1985), the Proulx patent (U.S. Pat. No. 5,304,741A issued in 1994), the Forbes patent (U.S. Pat. No. 7,388,155B2 issued in 2008), and others describe the skin effect as the tendency of higher frequency electrical signals to move and travel near the outer surface or skin of a wire whereas lower frequencies have a more even distribution from the surface to the center core of a wire.

Near the surface of a wire, this model suggests that the higher frequencies are subjected to a higher impedance and therefore greater attenuation than lower frequencies. To counter the skin effect, conventional solutions have focused almost exclusively on optimizing the numbers, sizes, and shapes of conductors comprising the wire and the geometries of the overall electrical cable, while using high conductivity conductors of copper, silver, aluminum, and related alloys to minimize resistive losses.

The second model used to describe the flow of electromagnetic energy is the transmission line. In this model, energy flows between the positive and ground or neutral conductors in the form of an electromagnetic wave with the conductors acting as wave guides. It is this model that the equations of physicist and mathematician James Clerk Maxwell show to be the truest representation of the transmission of electromagnetic energy in a cable.

Conventional solutions that attempt to mitigate skin effect related energy loss and phase errors generally do so by employing single or multiple small round or thin rectangular conductors in various geometries in order to limit the depth to which the electromagnetic wave penetrates radially. Further, the conventional solutions focused almost exclusively on using high conductivity conductors like copper, silver, aluminum, and related alloys to minimize resistive losses.

Only the Forbes patent attempts to minimize the skin effect using lower conductivity conductors. However, designed using the water in a pipe model, the Forbes patent teaches an electrical cable with hybrid conductors using a plethora of high and low conductivity materials to create specific pathways for various high to low frequency ranges. Viewed through the lens of the transmission line model, the Forbes cable uses a plethora of high and low conductive materials, each of which introduces its own conductivity-specific energy losses and phase errors to all frequencies.

These losses and errors are cumulative and result in audible degradation to a musical waveform carried by the cable.

Consequently, there exists the opportunity to design an improved conductive cable that further reduces, or eliminates completely, errors inherent in other designs. Therefore, what is desired is an improved conductive cable that transmits electromagnetic waveforms with minimum induced errors, distortions, or other undesirable alterations.

### SUMMARY OF THE INVENTION

The present inventive concept provides that for two conductors of the same size and shape, the conductor with the lower conductivity will experience less phase errors and less frequency dependent energy loss, compared to frequency independent losses, than the conductor with higher conductivity. This suggests that, as conductivity decreases, a wire will begin to act more like a pure resistor, with no frequency dependent losses and less phase errors, across the range of human hearing. The improved conductive cable according to the present general inventive concept is opposite of what a person skilled in the art would have used to reduce phase errors and frequency dependent energy loss in conductive cables. Therefore, the improved conductive cable according to the present general inventive concept provides an unexpected and unanticipated result.

It is an object of the improved electrical cable to provide a cable, designed as an interconnect cable between audio, video, and/or data equipment, that uses low conductivity and low magnetic permeability metal or metal alloy conductors to significantly reduce frequency dependent energy loss and phase errors in the transmitted signal.

It is an object of the improved electrical cable to provide a cable, designed as a speaker cable to connect audio amplifiers to speakers, that uses low conductivity and low magnetic permeability metal or metal alloy conductors to significantly reduce frequency dependent energy loss and phase errors in the transmitted signal.

Certain of the foregoing and related aspects and/or features are readily attained according to the present general inventive concept by providing an improved, signal carrying, electrically conductive cable having reduced frequency dependent energy loss and phase errors from end to end as a function of the frequency of audio-range signals conducted therein comprising one or more insulated, positive electrical wires with two ends and comprising of electrically conductive metal with conductivity between 0 and 3.2*10⁶ (ohm-meter)⁻¹ or between 0% and 5.5% International Annealed Copper Standard (IACS), and one or more insulated, neutral or ground wires with two ends and comprising of electrically conductive metal, wherein the electrically conductive metal of both positive and ground wires of the cable includes a relative magnetic permeability between 0 and 2.

The neutral or ground wires may be comprised of electrically conductive metal with conductivity less than 3.2*10⁶ (ohm-meter)⁻¹ or 5.5% IACS.

The neutral or ground wires may be comprised of electrically conductive metal with conductivity equal to or greater than 3.2*10⁶ (ohm-meter)⁻¹ or 5.5% IACS.

The positive wires may be comprised of a single, solid core conductor, a multi-stranded conductor, a plurality of individually insulated conductors, or any other configuration known in the art.

The neutral or ground wires may be comprised of a single, solid core conductor, a multi-stranded conductor, a plurality of individually insulated conductors, or any other configuration known in the art.

The positive wires may be comprised of one or more conductors that are round, oval, rectangular, square, foil, or any other shape known in the art.

The neutral or ground wires may be comprised of one or more conductors that are round, oval, rectangular, square, foil, or any other shape known in the art.

The insulated positive wires and insulated neutral or ground wires may be physically separated and independent from each other.

The insulated positive wires and insulated neutral or ground wires may be further encased in a single insulating body.

The insulated positive wires and insulated neutral or ground wires may not be encased in a single insulating body but connected by a means of maintaining a static distance between the wires.

The ends of said insulated positive wires and said insulated neutral or ground wires may have connectors are terminated in bare metal, RCA, XLR, spade lug, banana pin, or any other audio, video, or data connector known in the art.

Certain of the foregoing and related aspects and/or features are readily attained according to the present general inventive concept by also providing a method for reducing frequency dependent energy loss and phase errors from end to end as a function of the frequency of audio-range signals conducted therein, the method includes obtaining an electrical wire having a first end and an opposing second end and comprising of an electrically conductive metal with a conductivity less than about 3.2*10⁶ (ohm-meter)⁻¹ or 5.5% International Annealed Copper Standard (IACS) and relative magnetic permeability less than 2; and transmitting audio-range signals from the first end to the second end, wherein the frequency dependent energy loss and phase from the first end to the second end is a function of a frequency of the audio-range signals transmitted therein.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a front perspective view a conductive cable according to an embodiment of the present inventive concept;

FIG. 2 is a flowchart of a method of reducing frequency dependent energy loss and phase errors according to an embodiment of the present inventive concept;

FIG. 3 is a chart illustrating electrically conductive metals with a conductivity between 0 and 3.2*10⁶ (ohm-meter)⁻¹ or between 0% and 5.5% International Annealed Copper Standard (IACS) according to embodiments of the present inventive concept;

FIG. 4 is a skin depth versus frequency chart comparing copper, aluminum, and the conductive cable according to an embodiment of the present general inventive concept;

FIG. 5 is a radial velocity versus frequency chart comparing copper, aluminum, and the conductive cable according to an embodiment of the present general inventive concept.

FIG. 6 is a front perspective view a conductive cable according to another embodiment of the present inventive concept;

FIG. 7 is a front perspective view a conductive cable according to another embodiment of the present inventive concept; and

FIG. 8 is a front perspective view a conductive cable according to another embodiment of the present inventive concept.

### DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

In the transmission line model, the electromagnetic wave flows in the dielectric material between the conductors at a high percentage of the speed of light. At the dielectric-conductor boundary, the wave penetrates the conductor radially along the entire surface area of the conductor where it is slowed and attenuated at a rate which is dependent upon the frequency of the electromagnetic wave and the conductivity and relative magnetic permeability of the conductor. This loss wave within the conductor induces a conduction current density axially along the length of the conductor but since the loss wave penetrates radially into the conductor, the field strength, and hence the current density, are highest at the surface and decay as the wave propagates toward the conductor center. This model shows that higher frequency waves, due to their higher attenuation rates, have greater field strengths and associated current densities closer to the outer edge or skin of a conductor and lower frequency waves appear to have a more uniform field strength and current density from edge to center.

The equation for the attenuation of a sinusoidal electric field E propagating over time t and in a direction z within a conductor of finite conductivity can be shown to be:

E=E₀e^{-αz} sin (ωt−βz)

where α is defined as the attenuation constant; the distance travelled by the wave is governed by the phase constant

$$β ( β = \frac{2 π}{λ} )$$

where λ is the wavelength of the field; and ω, (2πf) radians/second, is the wave oscillation frequency.

Expressed in terms of electrical characteristics, the attenuation and phase constants can be defined by:

$${α}^{2} = \frac{{μϵω}^{2}}{2} [ {( 1 + {( \frac{σ}{ϵω} )}^{2} )}^{.5} - 1 ] and β = \frac{ω μ σ}{2 α}$$

where

σ is conductivity, (ohm-meter)-1

ε is permittivity, (farad/meter)

μ is permeability, (henry/meter)

t is time, (second)

The depth of penetration, also known as the skin depth, is defined as the distance of propagation in which the energy of the wave has been attenuated by a factor of 1/e or about 8.69 dB or:

$$δ = \frac{1}{α} = \sqrt{\frac{2}{μ ω σ}}$$

Also, at skin depth δ, the phase of the wave E, (βz) will change by 1 radian (57.3 degrees).

The velocity v (meters/second) of wave propagation or penetration is:

$$v = \frac{ω}{β}$$

In electrically conductive materials, σ>>εω. Therefore, the velocity of propagation of electromagnetic energy in a metal conductor can be written as:

$$v = \sqrt{\frac{2 ω}{μ σ}}$$

Using the electrical characteristics of copper:

σ=5.8*10⁷ (ohm-meter)⁻¹

μ=4π*10⁻⁷ henry/meter

The following Table 1 shows the skin depth and propagation velocity of an electromagnetic wave in copper at various audio frequencies:

TABLE 1

| Frequency f | Skin Depth δ | Velocity v |
|---|---|---|
| hertz | millimeters | meters/second |
| 50 | 9.35 | 2.93 |
| 100 | 6.61 | 4.15 |
| 1,000 | 2.09 | 13.12 |
| 10,000 | .66 | 41.50 |
| 20,000 | .47 | 58.69 |

While the primary electromagnetic wave propagates along the dielectric at nearly the speed of light, the above table shows that this secondary electromagnetic wave penetrates the conductor nearly radially and travels at significantly lower speeds. This secondary wave constitutes an error or memory wave which results in energy loss and phases errors that are dependent upon wave frequency and the conductivity and size of the conductor.

This suggests that, for two conductors of the same conductivity, but different sizes or thicknesses, the smaller or thinner conductor will experience less frequency dependent energy loss and phase errors than the larger or thicker conductor.

Using the electrical characteristics of aluminum:

σ=3.54*10⁷ (ohm-meter)⁻¹

μ=4π*10⁻⁷ henry/meter

The following Table 2 shows that the skin depth and propagation velocity of an electromagnetic wave in aluminum increase with aluminum's corresponding decrease in conductivity:

TABLE 2

| Frequency f | Skin Depth δ | Velocity v |
|---|---|---|
| hertz | millimeters | meters/second |
| 50 | 11.96 | 3.75 |
| 100 | 8.46 | 5.32 |
| 1,000 | 2.67 | 16.81 |
| 10,000 | .85 | 53.15 |
| 20,000 | .60 | 75.17 |

This suggests that, for two conductors of the same size and shape, the conductor with the lower conductivity will experience less frequency dependent energy loss and phase errors than the conductor with higher conductivity.

The International Annealed Copper Standard (IACS) establishes a standard for the conductivity of commercially pure annealed copper. The standard was established in 1913 by the International Electrotechnical Commission. The Commission established that, at 20° C., commercially pure, annealed copper has a resistivity of 1.7241×10⁻⁸ ohm-meter or 5.8×10⁷ (ohm-(or Siemens/meter) when expressed in terms of conductivity. For convenience, conductivity is frequently expressed in terms of percent IACS. A conductivity of 5.8×10⁷ S/m may be expressed as 100% IACS at 20° C. All other conductivity values are related back to this standard value of conductivity for annealed copper. Aluminum, with a conductivity of 3.54*10⁷ (ohm-m)⁻¹ (or Siemens/meter) at 20° C. may be expressed as 61% IACS.

Note that the permeability of both copper and aluminum, for use in calculating the values in the above tables, is listed as: μ=4π*10⁻⁷ henry/m. This value is equal to the permeability constant μ0 which is defined as the permeability of free space.

Relative magnetic permeability is defined as the ratio of the permeability of a specific material to the permeability of free space μ0:

μr=μ/μ0

where

μr is the relative magnetic permeability

μ is permeability of the material (henry/m)

Copper is weakly diamagnetic with a relative magnetic permeability of μr=0.999994. Aluminum is weakly paramagnetic with a relative magnetic permeability μr=1.000022. As most materials, including electrically conductive metals, have a relative magnetic permeability of μr≈1, it should be obvious that the very small differences in permeability of these electrically conductive metals will not produce any appreciable differences in frequency dependent energy loss or phase errors. However, it should also be obvious that the use of ferromagnetic materials, materials in which μr>>1, will result in greatly reduced skin depth and propagation velocity values for electromagnetic waves and that cables using these highly magnetically permeable materials will experience significant frequency dependent energy loss and phase errors. As an example, for nickel, its relative magnetic permeability μr>100. In the case of iron, μr>5000.

Frequency dependent energy loss can also be described by Alternating Current (AC) resistance, of which skin depth is also a function. Direct Current (DC) resistance is only a function of conductivity and wire size.

The AC resistance (ohm/meter) of a circular wire is:

$$Rac = \frac{- 1}{π δ ( 2 r - δ ) σ )}$$

where

σ is conductivity, (ohm-meter)-1

δ is skin depth, (meters)

r is radius of circular wire, (meters)

The DC resistance (ohm/meter) of a circular wire is:

$$Rdc = \frac{- 1}{π {r}^{2} σ}$$

where

94 is conductivity, (ohm-meter)-1

r is radius of circular wire, (meters)

The range of human hearing is generally described as 20 Hz to 20 kHz. Using the above conductivity value for copper, the following table 3 illustrates the change in AC resistance across the frequency range of human hearing and its percentage increase over DC resistance for a 12-gauge wire, a wire size commonly used in audio applications:

TABLE 3

| Frequency f | DC resistance | AC resistance | |
|---|---|---|---|
| hertz | ohms/meter | ohms/meter | % increase |
| 20 | .00503 | .00503 | 0% |
| 5,000 | .00503 | .005086 | 1% |
| 10,000 | .00503 | .005815 | 15.6% |
| 20,000 | .00503 | .007242 | 44.0% |

Using the above conductivity value for aluminum, the following table 4 illustrates the change in AC resistance across the frequency range of human hearing and its percentage increase over DC resistance for a 12 gauge wire:

TABLE 4

| Frequency f | DC resistance | AC resistance | |
|---|---|---|---|
| hertz | ohms/meter | ohms/meter | % increase |
| 20 | .008246 | .008246 | 0% |
| 5,000 | .008246 | .008246 | 0% |
| 10,000 | .008246 | .008555 | 3.7% |
| 20,000 | .008246 | .01009 | 22.3% |

This suggests that, for two conductors of the same size and shape, the conductor with the lower conductivity will experience less frequency dependent energy loss, compared to frequency independent losses, than the conductor with higher conductivity. This also suggests that, as conductivity decreases, a wire will begin to act more like a pure resistor, with no frequency dependent losses, across the range of human hearing.

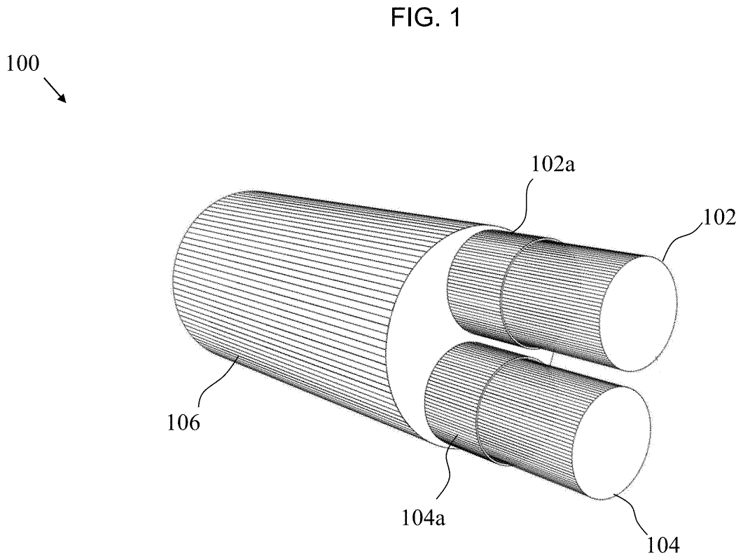

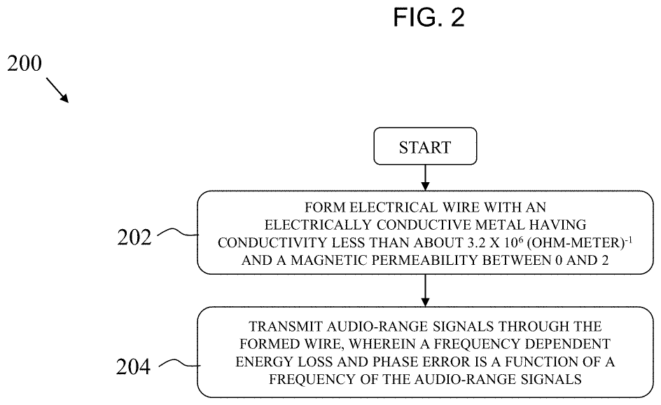

FIG. 1 is a front perspective view a conductive cable 100 according to an embodiment of the present inventive concept and FIG. 2 is a flowchart of a method 200 of reducing frequency dependent energy loss and phase errors according to an embodiment of the present inventive concept.

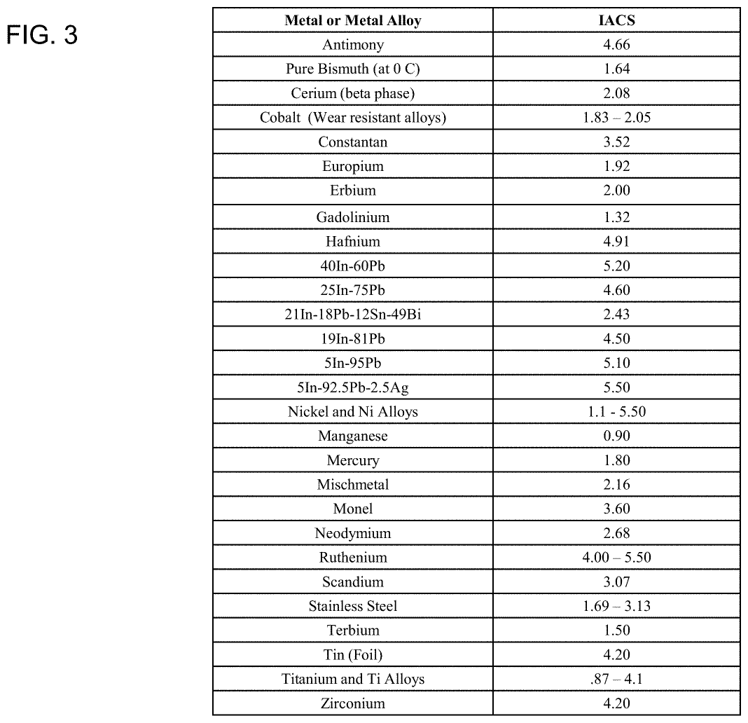

FIG. 3 is a chart illustrating electrically conductive metals with a conductivity between 0 and 3.2*10⁶ (ohm-meter)⁻¹ or between 0% and 5.5% International Annealed Copper Standard (IACS) according to embodiments of the present inventive concept.

In the present embodiment, the improved conductive cable according to the present general inventive concept is designed and configured to reduce and/or substantially eliminate errors within electromagnetic waveforms transmitted there through with minimum induced errors, distortions, or other undesirable alterations. The improved conductive cable according to the present general inventive concept utilizes a low conductivity cable which is in direct contravention to what a person skilled in the art would have and continues to use to resolve or address reducing electromagnetic waveform errors.

Referring now to FIG. 1, an improved conductive cable 100 according to the present general inventive concept includes a first solid core metal conductor 102 surrounded by a first insulated sleeve 102a and a second solid core metal conductor 104 surrounded by a second insulated sleeve 104a both enclosed within an insulating jacket 106.

The first and second solid core metal conductors 102, 104 are of a metal or metal alloy with conductivity between 0 and about 3.2*10⁶ (ohm-meter)⁻¹ or between 0 and about 5.5% IACS at 20° C. and a relative magnetic permeability between 0 and 2. In an embodiment, the first and second solid core metal conductors 102, 104 are of a metal or metal alloy with conductivity of about 3.2*10⁶ (ohm-meter)⁻¹ or about 5.5% IACS at 20° C. and a relative magnetic permeability μr≈1.

Referring to FIG. 2, a method 200 of reducing frequency dependent energy loss and phase errors within electromagnetic waveforms transmitted through an improved conductive cable 100 with minimum induced errors, distortions, or other undesirable alterations includes, at step 202, forming an improved conductive cable 100 (i.e., electrical wire) with an electrically conductive metal having conductivity between 0 and about 3.2*10⁶ (ohm-meter)⁻¹ or between 0 and about 5.5% IACS at 20° C. and a relative magnetic permeability of between 0 and 2. In an embodiment, the electrically conductive metal includes a metal or metal alloy with conductivity of about 3.2*10⁶ (ohm-meter)⁻¹ or about 5.5% IACS at 20° C. and a relative magnetic permeability μr≈1.

At step 204, the method 200 includes transmitting audio-range signals through the improved conductive cable 100, wherein a frequency dependent energy loss and phase error is a function of a frequency of the audio-range signals transmitted through the improved conductive cable 100.

The improved conductive cable 100 and method 200 according to the present general inventive concept improves upon conventional cables by increasing the radial transmission speed of the electromagnetic error wave in electrical cables in order to reduce the phase or timing errors in the signal.

The improved conductive cable 100 and method 200 according to the present general inventive concept also improves upon conventional cables by eliminating or substantially reducing frequency dependent energy loss across the frequency range of human hearing. Both improvements are achieved through the use of an improved electrical (i.e., conductive) cable, in any shape or geometry known in the art, with a metal conductor having a conductivity less than 3.2*10⁶ (ohm-meter)⁻¹ or 5.5% IACS and relative magnetic permeability of μr≈1.

Using the conductivity value of 5.5% IACS or σ=3.2*10⁶ (ohm-meter)⁻¹ and relative magnetic permeability of μr=1 for a hypothetical metal, the following Table 5 illustrates the change in AC resistance across the frequency range of human hearing and its percentage increase over DC resistance for a 12 gauge wire, a wire size commonly used in audio applications:

TABLE 5

| Frequency f | DC resistance | AC resistance | |
|---|---|---|---|
| Hertz | ohms/meter | ohms/meter | % increase |
| 20 | .09146 | .09146 | 0% |
| 5,000 | .09146 | .09146 | 0% |
| 10,000 | .09146 | .09146 | 0% |
| 20,000 | .09146 | .09146 | 0% |

Using the above hypothetical metal, the following Table 6 shows the improvement in radial propagation velocity of an electromagnetic wave in the hypothetical metal over copper at various audio frequencies:

TABLE 6

| | | Velocity in 5.5% IACS |
|---|---|---|
| Frequency f | Velocity in copper | metal |
| hertz | meters/second | meters/second |
| 50 | 2.93 | 12.52 |
| 100 | 4.15 | 17.71 |
| 1,000 | 13.12 | 55.99 |
| 10,000 | 41.50 | 177.05 |
| 20,000 | 58.69 | 250.39 |

Table 6 demonstrates that the radial electromagnetic error wave velocity is dramatically increased in the hypothetical metal conductor. The increased error wave velocity will result in a corresponding decrease in phase or timing errors in the primary signal.

Referring to FIG. 3, in exemplary embodiments, the first and second core metal conductors 102, 104 are formed of one of the metals or metal alloys selected from a group consisting of Antimony, pure Bismuth (at 0 oC), Cerium (beta phase), Cobalt (Wear resistant alloys), Constantan, Europium, Erbium, Gadolinium, Hafnium, 40In-60Pb, 251n-75Pb, 21In-18Pb-12Sn-49Bi, 19In-81Pb, 51n-95Pb, 51n-92.5Pb-2.5Ag, Nickel and Ni Alloys, Manganese, Mercury, Mischmetal, Monel, Neodymium, Ruthenium, Scandium, Stainless Steel, Terbium, Tin (Foil), Titanium and Ti Alloys, and Zirconium.

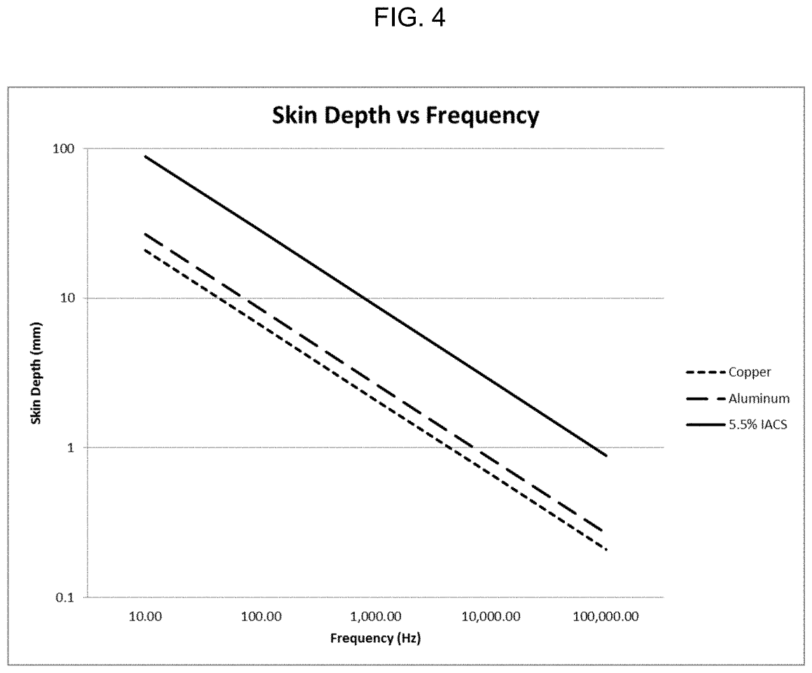

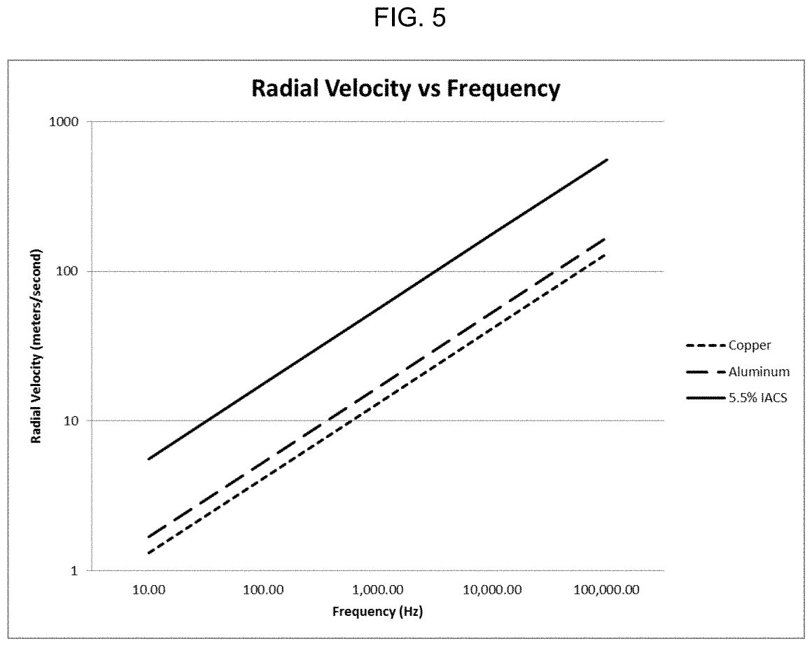

FIG. 4 is a skin depth versus frequency chart comparing copper, aluminum, and the conductive cable according to an embodiment of the present general inventive concept and FIG. 5 is a radial velocity versus frequency chart comparing copper, aluminum, and the conductive cable according to an embodiment of the present general inventive concept.

Referring to FIG. 4, the skin depth versus frequency chart compares copper, aluminum, and the conductive cable according to an embodiment of the present general inventive concept. As illustrated, an unexpected result of utilizing an electrically conductive metal having a conductivity less than 3.2*10⁶ (ohm-meter)⁻¹ or 5.5% IACS and relative magnetic permeability of μr≈1, is that the skin depth is significantly improved as compared to copper and aluminum.

Referring to FIG. 5, the radial velocity versus frequency chart compares copper, aluminum, and the conductive cable according to an embodiment of the present general inventive concept. As illustrated, an unexpected result of utilizing an electrically conductive metal having a conductivity less than 3.2*10⁶ (ohm-meter)⁻¹ or 5.5% IACS and relative magnetic permeability of μr≈1, is that the radial velocity is significantly improved as compared to copper and aluminum.

In the art, an audio interconnect cable consists of a pair of RCA, XLR, or similar connectors, each with one or more male or female positive pins and one or more male or female ground or neutral pins. Each of the first connector's pins is connected to the corresponding pin on the second connector using an insulated electrical wire.

In alternative embodiments, the improved conductive cable 100 may be comprised of a single, solid core conductor, a multi-stranded conductor, bundles of individually insulated conductors, or any other configuration known in the art. However, the present general inventive concept is not limited thereto.

In exemplary embodiments, the first and second solid core metal conductors 102, 104 may be round, rectangular or flat, or any other shape known in the art. However, the present general inventive concept is not limited thereto.

In the present embodiment, the first metal conductor 102 (positive) and the second metal conductor 104 (ground or neutral) are formed of a metal or metal alloy with a conductivity of less than 5.5% IACS at 20° C. and a relative magnetic permeability of μr≈1.

The improved conductive cable 100 may be formed as a speaker cable consisting of one or more insulated positive wires and one or more insulated ground or neutral wires. These insulated wires may be physically separate from each other or, as is most often the case, encased in a single insulated body. Each positive and negative wire is individually terminated in a spade lug, banana plug, bare wire, or any other connector known in the art for connecting a wire to a binding post on an amplifier or a speaker. Wires may be comprised of a single, solid core conductor, a multi-stranded conductor, bundles of individually insulated conductors, or any other configuration known in the art.

The first and second metal conductors 102, 104 may be round, rectangular or flat, or any other shape known in the art. In this preferred embodiment, the positive and ground or neutral conductors are of a metal or metal alloy with conductivity less than 5.5% IACS at 20° C. and a relative magnetic permeability of μr≈1.

In alternative embodiments, the improved conductive cable 100 may be formed as an audio interconnect cable consisting of a pair of RCA, XLR, or similar connectors, each with one or more male or female positive pins and one or more male or female ground or neutral pins. Each of the first connector's pins is connected to the corresponding pin on the second connector using an insulated electrical wire. Electrical wires may be comprised of a single, solid core conductor, a multi-stranded conductor, bundles of individually insulated conductors, or any other configuration known in the art. The conductors may be round, rectangular or flat, or any other shape known in the art. In some cases, for electrical safety, to minimize ground noise or ground loop hum, or for purposes of electromagnetic shielding, it is desirable for the ground or neutral wires to have very low DC resistance.

In this alternate embodiment, the positive conductors are of a metal or metal alloy with conductivity less than 5.5% IACS at 20° C. and a relative magnetic permeability of μr≈1. In order to achieve low DC resistance, the ground or neutral conductors may be of a metal or metal alloy with conductivity greater than 5.5% IACS 20° C. and a relative magnetic permeability of μr≈1.

In the art, a speaker cable consists of one or more insulated positive wires and one or more insulated ground or neutral wires. These wires may be separate from each other or, as is most often the case, encased in a single insulated body. Each positive and negative wire is individually terminated in a spade lug, banana plug, bare wire, or any other connector known in the art for connecting a wire to a binding post on an amplifier or a speaker. Wires may be comprised of a single, solid core conductor, a multi-stranded conductor, bundles of individually insulated conductors, or any other configuration known in the art. The conductors may be round, rectangular or flat, or any other shape known in the art. In some cases, for purposes of electromagnetic shielding, or to maximize amplifier damping factor, it is desirable for the ground or neutral wires to have very low DC resistance. In this alternate embodiment, the positive conductors are of a metal or metal alloy with conductivity less than 5.5% IACS at 20° C. and a relative magnetic permeability of μr≈1. In order to achieve low DC resistance, the ground or neutral conductors may be of a metal or metal alloy with conductivity greater than 5.5% IACS 20° C. and a relative magnetic permeability of μr≈1.

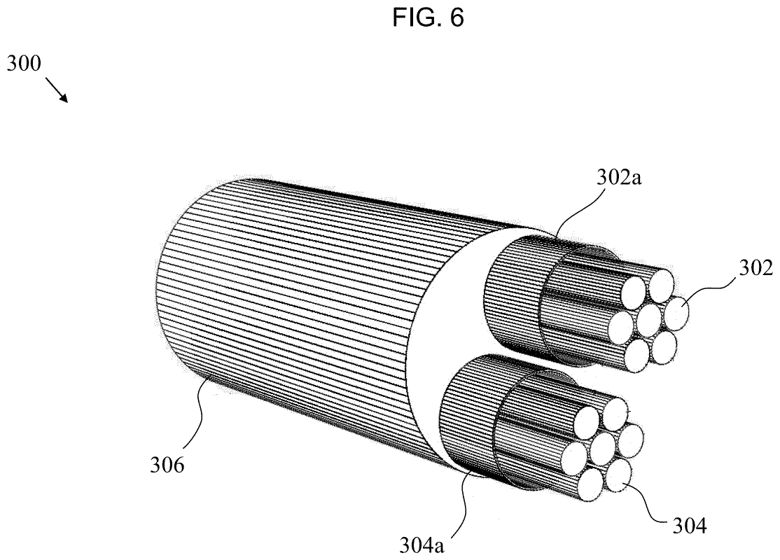

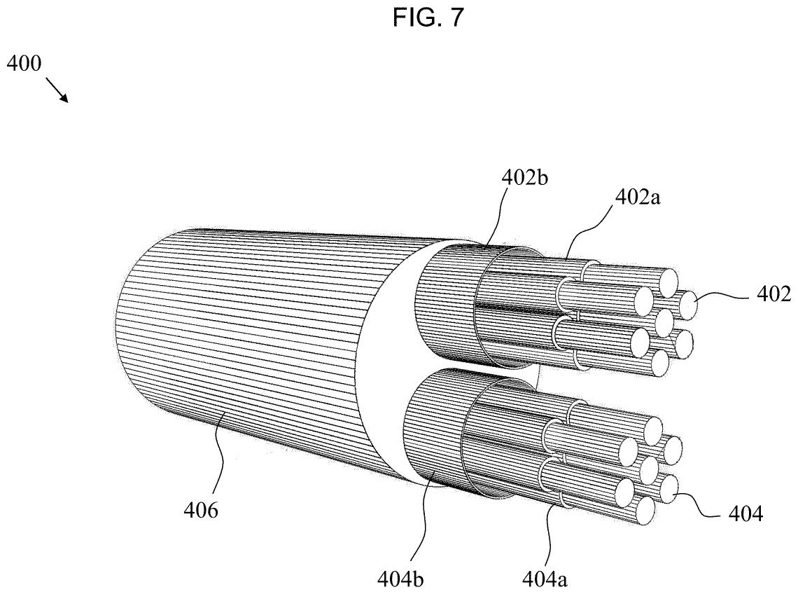

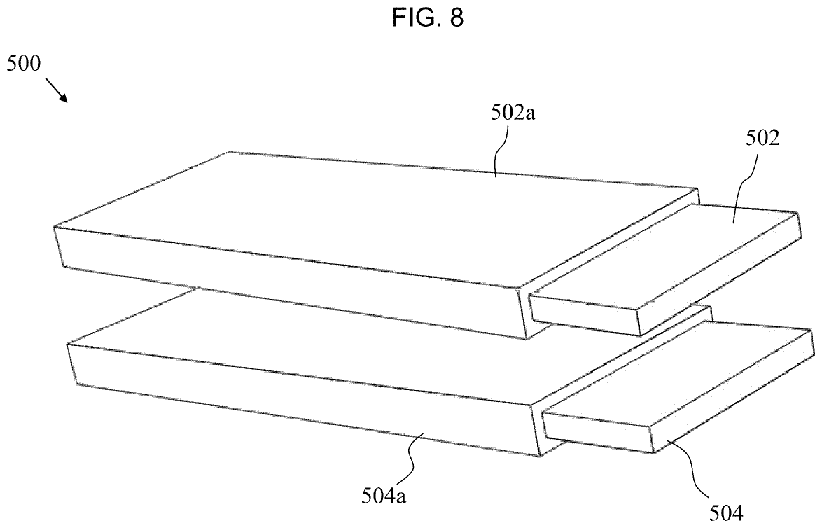

FIG. 6 is a front perspective view a conductive cable according to another embodiment of the present inventive concept, FIG. 7 is a front perspective view a conductive cable according to another embodiment of the present inventive concept, and FIG. 8 is a front perspective view a conductive cable according to another embodiment of the present inventive concept.

Referring now to FIG. 6, an improved conductive cable 300 according to the present general inventive concept includes a plurality of first stranded wire metal conductors 302 surrounded by a first insulated sleeve 302a and a plurality of second stranded wire conductors 304 surrounded by a second insulated sleeve 304a, wherein the plurality of first and second stranded wire metal conducts 302, 304 are enclosed within an insulating jacket 306.

The plurality of first and second solid core metal conductors 302, 304 are of a metal or metal alloy with conductivity between 0 and about 3.2*10⁶ (ohm-meter)⁻¹ or between 0 and about 5.5% IACS at 20° C. and a relative magnetic permeability between 0 and 2. In an embodiment, the plurality of first and second solid core metal conductors 302, 304 are of a metal or metal alloy with conductivity of about 3.2*10⁶ (ohm-meter)⁻¹ or about 5.5% IACS at 20° C. and a relative magnetic permeability μr≈1.

However, in alternative embodiments, the positive conductors are of a metal or metal alloy with conductivity less than 5.5% IACS at 20° C. and a relative magnetic permeability of 1. In order to achieve low DC resistance, the ground or neutral conductors may be of a metal or metal alloy with conductivity greater than 5.5% IACS 20° C. and a relative magnetic permeability of μr≈1.

Referring now to FIG. 7, an improved conductive cable 400 according to the present general inventive concept includes a plurality of first individually insulated stranded wire metal conductors 402 each surrounded by an insulated sleeve 402a and a plurality of second individually insulated stranded wire metal conductors 404 each surrounded by an insulated sleeve 404a. The plurality of first individually insulated stranded wire metal conductors 402 and the insulated sleeve 402a is enclosed in a separate insulated sleeve 402b. Similarly, the plurality of second individually insulated stranded wire metal conductors 404 and the insulated sleeve 404a is enclosed in a separate insulated sleeve 404b.

Further, as illustrated in FIG. 7, the plurality of first individually insulated stranded wire metal conductors 402 and the plurality of second individually insulated stranded wire metal conductors 404 are all enclosed within an insulating jacket 406.

The plurality of first and second individually insulated stranded wire metal conductors 402, 404 are of a metal or metal alloy with conductivity between 0 and about 3.2*10⁶ (ohm-meter)⁻¹ or between 0 and about 5.5% IACS at 20° C. and a relative magnetic permeability between 0 and 2. In an embodiment, the plurality of first and second solid core metal conductors 402, 404 are of a metal or metal alloy with conductivity of about 3.2*10⁶ (ohm-meter)⁻¹ or about 5.5% IACS at 20° C. and a relative magnetic permeability μr≈1.

However, in alternative embodiments, the positive conductors are of a metal or metal alloy with conductivity less than 5.5% IACS at 20° C. and a relative magnetic permeability of μr≈1. In order to achieve low DC resistance, the ground or neutral conductors may be of a metal or metal alloy with conductivity greater than 5.5% IACS 20° C. and a relative magnetic permeability of μr≈1.

Referring now to FIG. 8, an improved conductive cable 500 according to the present general inventive concept includes a first solid rectangular shaped core metal conductor 502 surrounded by a first insulated sleeve 502a and a second solid rectangular shaped core metal conductor 504 surrounded by a second insulated sleeve 504a.

The first and second solid metal conductors 502, 504 are of a metal or metal alloy with conductivity between 0 and about 3.2*10⁶ (ohm-meter)⁻¹ or between 0 and about 5.5% IACS at 20° C. and a relative magnetic permeability between 0 and 2. In an embodiment, the first and second solid rectangular shaped core metal conductors 502, 504 are of a metal or metal alloy with conductivity of about 3.2*10⁶ (ohm-meter)⁻¹ or about 5.5% IACS at 20° C. and a relative magnetic permeability μr≈1.

However, in alternative embodiments, the positive conductors are of a metal or metal alloy with conductivity less than 5.5% IACS at 20° C. and a relative magnetic permeability of μr≈1. In order to achieve low DC resistance, the ground or neutral conductors may be of a metal or metal alloy with conductivity greater than 5.5% IACS 20° C. and a relative magnetic permeability of μr≈1.

While the improved electrically conductive cable of the present invention as herein disclosed in detail is fully capable of obtaining the objects and providing the advantages and improvements herein before stated, it is to be understood that it is merely illustrative of a preferred embodiment and one of many alternative embodiments of the invention and that no limitations are intended to the details of the construction or design herein described other than as described in the appended claims.

What is claimed is:

1. An improved, signal carrying, electrically conductive cable having reduced frequency dependent energy loss and phase errors from end to end as a function of the frequency of audio-range signals conducted therein comprising:
a. one or more insulated, first electrical wires with two ends and comprising of a first electrically conductive metal with a conductivity between 0 and 3.2*10⁶ (ohm-meter)⁻¹ or between 0% and 5.5% International Annealed Copper Standard (IACS); and
b. one or more insulated, second electrical wires with two ends and comprising of a second electrically conductive metal,
wherein the first electrically conductive metal includes a relative magnetic permeability between 0 and 2.

2. The improved electrically conductive cable in claim 1, wherein the second electrical wire is comprised of a second electrically conductive metal with a conductivity between 0 and 3.2*10⁶ (ohm-meter)⁻¹ or 0% and 5.5% IACS.

3. The improved electrically conductive cable in claim 2, wherein the second electrically conductive metal includes a relative magnetic permeability between 0 and 2.

4. The improved electrically conductive cable in claim 1, wherein the second electrical wires are neutral or ground wires comprised of an electrically conductive metal with a conductivity equal to or greater than 3.2*10⁶ (ohm-meter)⁻¹ or 5.5% IACS.

5. The improved electrically conductive cable in claim 1, wherein the first electrical wires are comprised of a single, solid core conductor, a multi-stranded conductor, a plurality of individually insulated conductors, or any other configuration known in the art.

6. The improved electrically conductive cable in claim 1, wherein the second electrical wires are comprised of a single, solid core conductor, a multi-stranded conductor, a plurality of individually insulated conductors, or any other configuration known in the art.

7. The improved electrically conductive cable in claim 1, wherein the first electrical wires are comprised of one or more conductors that are round, oval, rectangular, square, foil, or any other shape known in the art.

8. The improved electrically conductive cable in claim 1, wherein the second electrical wires are comprised of one or more conductors that are round, oval, rectangular, square, foil, or any other shape known in the art.

9. The improved electrically conductive cable in claim 1, wherein the first and second electrical wires are physically separated and independent from each other.

10. The improved electrically conductive cable in claim 1, wherein the first and second electrical wires are further encased in a single insulating body.

11. The improved electrically conductive cable in claim 1, wherein the first and second electrical wires are not encased in a single insulating body but connected by a means of maintaining a static distance between the first and second wires.

12. The improved electrically conductive cable in claim 1, wherein said ends of the first and second electrical wires have connectors that are terminated in bare metal, RCA, XLR, spade lug, banana pin, or any other audio, video, or data connector known in the art.

13. A method for reducing frequency dependent energy loss and phase errors from end to end as a function of the frequency of audio-range signals conducted therein, the method comprising:
obtaining a first electrical wire having a first end and an opposing second end and comprising of a first electrically conductive metal with a conductivity between 0 and about 3.2*10⁶ (ohm-meter)⁻¹ or between 0 and about 5.5% International Annealed Copper Standard (IACS), wherein the first electrically conductive metal includes a relative magnetic permeability between 0 and 2, and a second electrical wire having a first end and an opposing second end; and
transmitting audio-range signals from the first end to the second end,
wherein the frequency dependent energy loss and phase from the first end to the second end is a function of a frequency of the audio-range signals transmitted therein.

14. The method of claim 13, wherein the second electrical wire comprises a second electrically conductive metal with a conductivity between 0 and about 3.2*10⁶ (ohm-meter)⁻¹ or between 0 and about 5.5% International Annealed Copper Standard (IACS), wherein the second electrically conductive metal includes a relative magnetic permeability between 0 and 2.

15. The improved electrically conductive cable in claim 13, wherein the second electrical wire is a neutral or ground wire comprised of a second electrically conductive metal with a conductivity equal to or greater than 3.2*10⁶ (ohm-meter)⁻¹ or 5.5% IACS.

16. The method of claim 15, wherein the first electrically conductive metal of the first electrical wire includes a relative magnetic permeability of about 1.

17. The method of claim 16, wherein the second electrically conductive metal of the second electrical wire includes a relative magnetic permeability of about 1.

18. The method of claim 15, wherein the first electrically conductive metal of the first electrical wire is physically separated and independent from the second electrically conductive metal of the second electrical wire.

19. The method of claim 15, wherein the first and second electrically conductive metals of the first and second electrical wires are formed as one shape of round, oval, rectangular, square and foil.
